(19) United States
(12) Patent Application Publication
(10) Pub. No.: US 2013/0335276 A1
(43) Pub. Date: Dec. 19, 2013

(54) ELECTRONIC COMMUNICATION DEVICE WITH ANTENNA STRUCTURE

(71) Applicants: WEN-HSIEN LEE, YUANSHAN TOWNSHIP (TW); SHIH-PO LO, NEW TAIPEI CITY (TW)

(72) Inventors: WEN-HSIEN LEE, YUANSHAN TOWNSHIP (TW); SHIH-PO LO, NEW TAIPEI CITY (TW)

(73) Assignee: ASKEY COMPUTER CORP.

(21) Appl. No.: 13/596,212

(22) Filed: Aug. 28, 2012

(30) Foreign Application Priority Data
Jun. 19, 2012 (TW) 101211809

(51) Int. Cl. H01Q 1/24

(52) U.S. Cl. 343/702

(57) ABSTRACT

An electronic communication device with an antenna structure includes a casing defining a receiving space therein, a circuit board, an antenna module, and at least an elastic conductive element. The circuit board is received in the receiving space and has a first electrically connecting portion. The antenna module is received in the receiving space and has a second electrically connecting portion corresponding in position to the first electrically connecting portion. The elastic conductive element is disposed between the circuit board and the antenna module and corresponds in position to the first and second electrically connecting portions. The elastic conductive element produces an elastic deforming force to enable electrical connection between the first and second electrically connecting portions and thereby enable electrical connection between the circuit board and the antenna module, thereby facilitating assembly and dispensing with a cable otherwise required to connect the antenna module and the circuit board.

### CROSS-REFERENCE TO RELATED APPLICATION

This non-provisional application claims priority under 35 U.S.C. §119(a) on Patent Application No(s). 101211809 filed in Taiwan, R.O.C. on Jun. 19, 2012, the entire contents of which are hereby incorporated by reference.

### FIELD OF TECHNOLOGY

The present invention relates to electronic communication devices, and more particularly, to an electronic communication device with an antenna structure.

### BACKGROUND

In general, the casing of an electronic communication device often accommodates a circuit board for laying a circuit as well as an antenna module, a port, and other components for receiving or transmitting a signal. The casing comprises a first case and a second case. For example, the antenna module is a flexible printed circuit antenna (FPC antenna) electrically connected to the circuit board by an antenna cable. The antenna cable has one end soldered to the antenna module. To assemble the electronic communication device, it is necessary to put the circuit board in the second case and has the antenna module adhered to the second case from inside so as for the antenna module to be fixed to the second case. The antenna cable has the other end connected to the circuit board by a conductive terminal. Finally, the first case and the second case are coupled together to finish the assembly of the electronic communication device.

However, the aforesaid prior art has its drawbacks. The antenna cable occupies the internal space of the electronic communication device at the cost of the reduction in the space available to an expansion circuit or a heat dissipation route. To couple the first case and the second case together, it is necessary to adjust the position of the antenna cable appropriately without compromising the electrical connection of the antenna module and the circuit board and then connect the other end of the antenna cable to the circuit board by a conductive terminal or by soldering so as to prevent the antenna cable from affecting the electronic components on the circuit board or hindering the coupling process performed on the first case and the second case. Hence, the prior art teaches an antenna cable is subjected to a limitation of internal space and flawed with a complicated assembly process.

### SUMMARY

It is an objective of the present invention to provide an electronic communication device with an antenna structure to effectuate electrical connection of an antenna module and a circuit board by means of an elastic conductive element.

Another objective of the present invention is to provide an electronic communication device with an antenna structure to overcome related drawbacks of the prior art, that is, a space-occupying cable connected between the antenna module and the circuit board, and a complicated assembly process.

In order to achieve the above and other objectives, the present invention provides an electronic communication device with an antenna structure. The electronic communication device comprises: a casing defining a receiving space therein; a circuit board received in the receiving space and having a first electrically connecting portion; an antenna module received in the receiving space, corresponding in position to the circuit board, and having a second electrically connecting portion corresponding in position to the first electrically connecting portion; and at least an elastic conductive element disposed between the circuit board and the antenna module and corresponding in position to the first electrically connecting portion and the second electrically connecting portion, such that the circuit board and the antenna module are electrically connected by means of an elastic deforming force exerted by the at least an elastic conductive element and electrical connection between the first electrically connecting portion and the second electrically connecting portion.

As regards the electronic communication device, the casing comprises a first case and a second case coupled thereto to form the receiving space therebetween, the first case housing the antenna module, and the second case housing the circuit board.

As regards the electronic communication device, the at least an elastic conductive element is a metallic leaf spring and is of a height larger than a distance between an inner surface of the first case and the circuit board, wherein the at least an elastic conductive element has at least a bend portion, and the at least a bend portion is curved.

As regards the electronic communication device, the at least an elastic conductive element is a metallic spring and is of an original height larger than a distance between an inner surface of the casing and the circuit board.

As regards the electronic communication device, the antenna module is a flexible printed circuit antenna (FPC antenna), wherein the second electrically connecting portion is a copper foil exposed from the flexible printed circuit antenna.

In an embodiment of the present invention, an electronic communication device with an antenna structure comprises a casing, a circuit board, an antenna module, and at least an elastic conductive element. The antenna module is disposed on an inner surface of the casing. A second electrically connecting portion of the antenna module corresponds in position to a first electrically connecting portion of the circuit board. The at least an elastic conductive element comes into contact with the second electrically connecting portion of the antenna module and the first electrically connecting portion of the circuit board to thereby enable the electrical connection between the antenna module and the circuit board. With the antenna module being disposed on the inner surface of the casing, the use of the space between the circuit board and the casing is efficient enough to enhance the utilization of internal space, thereby dispensing with a conventional cable that is required to connect the antenna module and the circuit board according to the prior art, occupies the internal space of the electronic communication device, and compromises an assembly process.

### BRIEF DESCRIPTION OF THE DRAWINGS

Objectives, features, and advantages of the present invention are hereunder illustrated with specific embodiments in conjunction with the accompanying drawings, in which:

FIG. 1 is an exploded view of an electronic communication device with an antenna structure according to an embodiment of the present invention;

FIG. 2 is a cross-sectional view of the electronic communication device with an antenna structure according to an embodiment of the present invention;

FIG. 3 is a perspective view of an elastic conductive element of the electronic communication device according to an embodiment of the present invention;

FIG. 4 is a perspective view of the elastic conductive element according to another embodiment of the present invention; and

FIG. 5 is a perspective view of the elastic conductive element according to yet another embodiment of the present invention.

### DETAILED DESCRIPTION

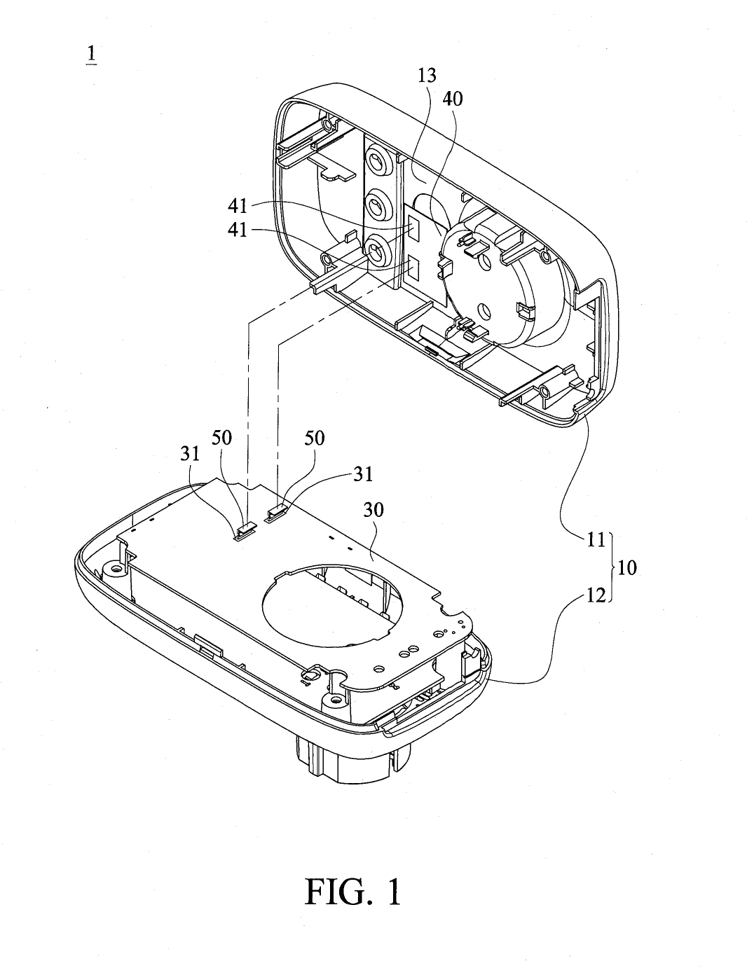

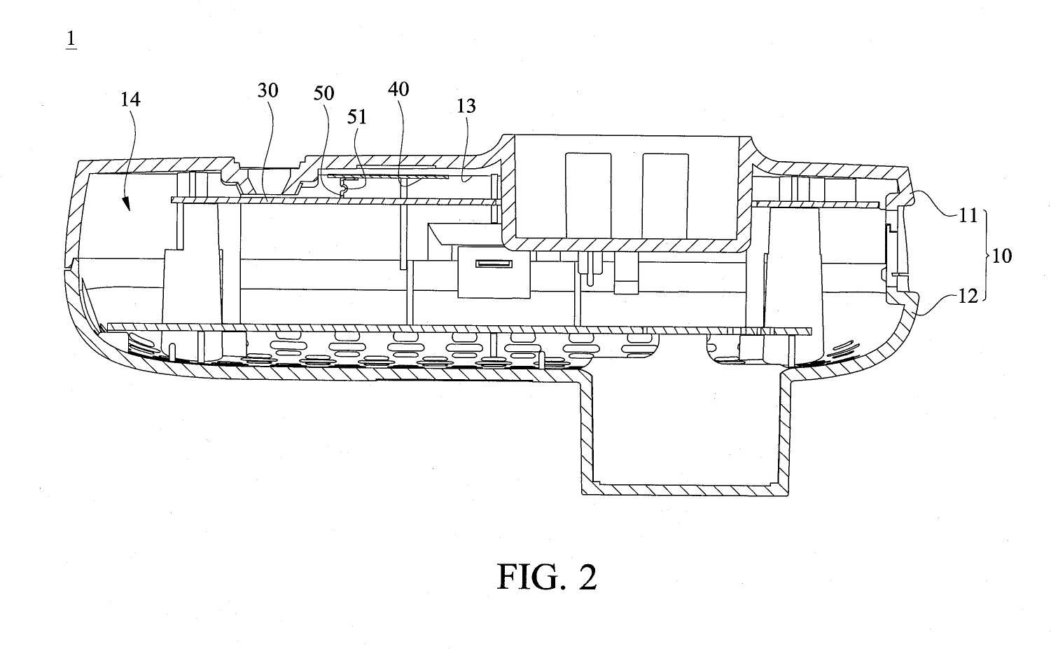

Referring to FIG. 1 and FIG. 2, there are shown an exploded view and a cross-sectional view of an electronic communication device with an antenna structure according to an embodiment of the present invention, respectively.

In an embodiment of the present invention, an electronic communication device 1 with an antenna structure essentially comprises a casing 10, a circuit board 30, an antenna module 40, and at least an elastic conductive element 50. The casing 10 comprises a first case 11 and a second case 12 and defines a receiving space 14 therein (see FIG. 2). That is to say, the first case 11 and the second case 12 are coupled together to form the receiving space 14. The circuit board 30 is received in the receiving space 14. The circuit board 30 has a first electrically connecting portion 31. The antenna module 40 is received in the receiving space 14, corresponds in position to the circuit board 30, and has a second electrically connecting portion 41 corresponding in position to the first electrically connecting portion 31. The at least an elastic conductive element 50 is disposed between the circuit board 30 and the antenna module 40 and corresponds in position to the first electrically connecting portion 31 and the second electrically connecting portion 41, such that the circuit board 30 and the antenna module 40 are electrically connected by means of an elastic deforming force exerted by the at least an elastic conductive element 50 and electrical connection between the first electrically connecting portion 31 and the second electrically connecting portion 41. In this embodiment, the antenna module 40 is disposed on an inner surface 13 of the first case 11, whereas the circuit board 30 is disposed in the second case 12.

In an embodiment of the present invention, in the electronic communication device 1, the antenna module 40 is a flexible printed circuit antenna (FPC antenna), and the second electrically connecting portion 41 is a copper foil exposed from the flexible printed circuit antenna. The antenna module 40 is adhered to the inner surface 13 of the first case 11 by means of a backing adhesive and thereby received in the receiving space 14, such that the antenna module 40 corresponds in position to the circuit board 30. Furthermore, for example, two said elastic conductive elements 50 are provided and connected to the first electrically connecting portion 31 of the circuit board 30 and the second electrically connecting portion 41 of the antenna module 40, respectively, such that the circuit board 30 and the antenna module 40 are electrically connected by means of the elastic conductive elements 50.

In an embodiment of the present invention, in the electronic communication device 1, the at least an elastic conductive element 50 is coupled to the circuit board 30 by soldering, such that the at least an elastic conductive element 50 is fixed to the circuit board 30, thereby allowing electrical conduction to take place between the at least an elastic conductive element 50 and the first electrically connecting portion 31 of the circuit board 30. The at least an elastic conductive element 50 corresponds in position to the second electrically connecting portion 41 of the antenna module 40, such that the electrical connection between the antenna module 40 and the circuit board 30 is achieved by coupling the first case 11 and the second case 12 together. In this embodiment, as shown in FIG. 3, the at least an elastic conductive element 50 is a metallic leaf spring, and the original height of the elastic conductive element 50 is larger than the distance between the circuit board 30 and the inner surface 13 of the first case 11. That is to say, the metallic leaf spring is of a height larger than the distance between the circuit board 30 and the inner surface 13 of the first case 11. The metallic leaf spring has at least a bend portion 51. The at least a bend portion 51 is curved. That is to say, the at least an elastic conductive element 50 is a metallic leaf spring with the curved bend portion 51. Hence, coupling the first case 11 and the second case 12 together enables the at least an elastic conductive element 50 to be compressed to thereby produce an elastic deforming force and come into physical contact with the second electrically connecting portion 41. Hence, the at least a bend portion 51 of the at least an elastic conductive element 50 undergoes elastic deformation, and thus the first electrically connecting portion 31 of the circuit board 30 and the second electrically connecting portion 41 of the antenna module 40 are electrically connected by means of the at least an elastic conductive element 50.

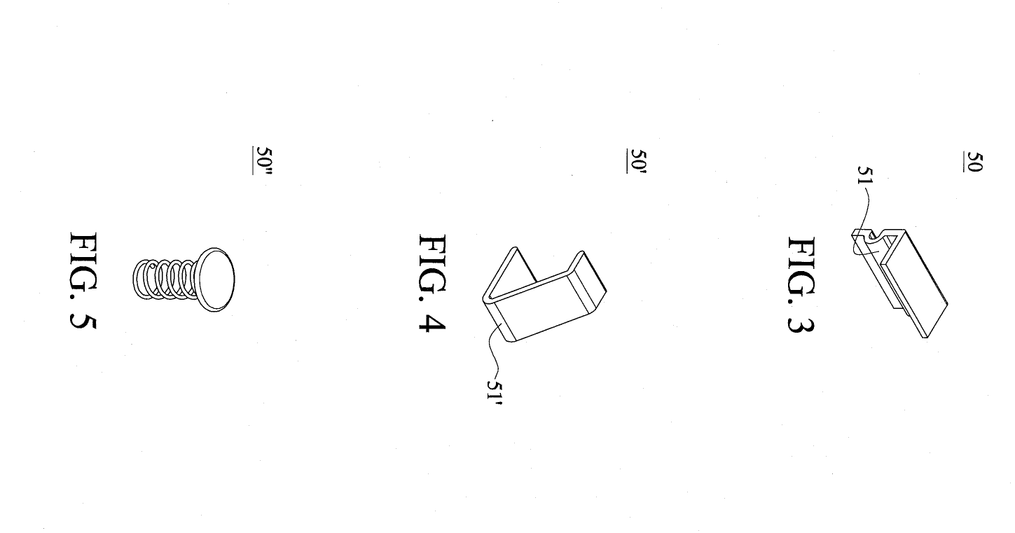

Referring to FIG. 4, at least an elastic conductive element 50′ is the metallic leaf spring in another embodiment of the present invention. The metallic leaf spring has at least a curved bend portion 51′. The at least a bend portion 51′ produces an elastic deforming force as soon as the at least an elastic conductive element 50′ comes into contact with the first electrically connecting portion 31 and the second electrically connecting portion 41 to be electrically connected, such that the first electrically connecting portion 31 of the circuit board 30 and the second electrically connecting portion 41 of the antenna module 40 are electrically connected because of the at least an elastic conductive element 50′. Furthermore, the at least an elastic conductive element is not restricted to the metallic leaf spring shown in the diagrams, but can be any metallic sheet that comes in appropriate dimensions and has a bend portion to allow the at least an elastic conductive element 50′ to undergo an appropriate degree of elastic deformation as soon as it comes into contact with the first electrically connecting portion 31 and the second electrically connecting portion 41.

Referring to FIG. 5, there is shown a perspective view of at least an elastic conductive element 50″ in yet another embodiment of the present invention. The at least an elastic conductive element 50″ is a metallic spring. Referring to FIG. 1, FIG. 2, and FIG. 5, the metallic spring is of an original height larger than the distance between the circuit board 30 and the inner surface 13 of the first case 11 of the casing 10 such that, once the first case 11 is coupled to the second case 12, the at least an elastic conductive element 50″ will be compressed to thereby produce an elastic deforming force and come into physical contact with the second electrically connecting portion 41 of the antenna module 40 disposed on the inner surface 13. As a result, the at least an elastic conductive element 50″ is in tight contact with the second electrically connecting portion 41 of the antenna module 40, such that the first electrically connecting portion 31 of the circuit board 30 and the second electrically connecting portion 41 of the antenna module 40 are electrically connected by means of the at least an elastic conductive element 50″.

In an embodiment of the present invention, in the electronic communication device 1, the second electrically connecting portion 41 of the antenna module 40 corresponds in position to the first electrically connecting portion 31 of the circuit board 30, and thus the antenna module 40 disposed in the receiving space 14 inside the casing 10 (i.e., the antenna module 40 disposed on the inner surface 13 of the first case 11) corresponds in position to the first electrically connecting portion 31 of the circuit board 30 and the elastic conductive elements 50, 50′, 50″. Hence, the positions of the antenna module 40, the first electrically connecting portion 31, and the elastic conductive elements 50, 50′, 50″ within the receiving space 14 can be designed and adjusted in accordance with the structures inside the casing 10 (the first case 11 and the second case 12) or a circuit and electronic components on the circuit board 30, but are not restricted to the disclosure contained in the embodiments and the drawings of the present invention.

Accordingly, in an embodiment of the present invention, an electronic communication device with an antenna structure comprises a casing, a circuit board, an antenna module, and at least an elastic conductive element. The antenna module is disposed on an inner surface of the casing. A second electrically connecting portion of the antenna module corresponds in position to a first electrically connecting portion of the circuit board. The at least an elastic conductive element comes into contact with the second electrically connecting portion of the antenna module and the first electrically connecting portion of the circuit board to thereby enable the electrical connection between the antenna module and the circuit board. With the antenna module being disposed on the inner surface of the casing, the use of the space between the circuit board and the casing is efficient enough to enhance the utilization of internal space, thereby dispensing with a conventional cable that is required to connect the antenna module and the circuit board according to the prior art, occupies the internal space of the electronic communication device, and compromises an assembly process.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An electronic communication device with an antenna structure, comprising:
a casing defining a receiving space therein;
a circuit board received in the receiving space and having a first electrically connecting portion;
an antenna module received in the receiving space, corresponding in position to the circuit board, and having a second electrically connecting portion corresponding in position to the first electrically connecting portion; and
at least an elastic conductive element disposed between the circuit board and the antenna module and corresponding in position to the first electrically connecting portion and the second electrically connecting portion, such that the circuit board and the antenna module are electrically connected by means of an elastic deforming force exerted by the at least an elastic conductive element and electrical connection between the first electrically connecting portion and the second electrically connecting portion.

2. The electronic communication device of claim 1, wherein the casing comprises a first case and a second case coupled thereto to form the receiving space therebetween, the first case housing the antenna module, and the second case housing the circuit board.

3. The electronic communication device of claim 2, wherein the at least an elastic conductive element is a metallic leaf spring and is of a height larger than a distance between an inner surface of the first case and the circuit board.

4. The electronic communication device of claim 3, wherein the at least an elastic conductive element has at least a bend portion which is curved.

5. The electronic communication device of claim 1, wherein the at least an elastic conductive element is a metallic spring and is of an original height larger than a distance between an inner surface of the casing and the circuit board.

6. The electronic communication device of claim 1, wherein the antenna module is a flexible printed circuit antenna (FPC antenna).

7. The electronic communication device of claim 6, wherein the second electrically connecting portion is a copper foil exposed from the flexible printed circuit antenna.
